(19) United States
(12) Patent Application Publication
(10) Pub. No.: US 2015/0042980 A1
(43) Pub. Date: Feb. 12, 2015

(54) DEVICE FOR DETECTING QUALITY LEVEL OF MICROELECTRONIC PACKAGING SAMPLES USING PHOTO-THERMAL IMAGING

(71) Applicants: Huazhong University of Science and Technology, Wuhan (CN); FineMEMS Inc., Wuhan (CN)

(72) Inventors: Sheng LIU, Wuhan (CN); Yiquan DAI, Wuhan (CN); Zhiyin GAN, Wuhan (CN); Xiaoping WANG, Wuhan (CN)

(21) Appl. No.: 14/522,667

(22) Filed: Oct. 24, 2014

Related U.S. Application Data
(63) Continuation-in-part of application No. PCT/CN2012/084560, filed on Nov. 14, 2012.

(30) Foreign Application Priority Data
Sep. 28, 2012 (CN) 201210366219.4

(51) Int. Cl. G01N 21/95

(52) U.S. Cl. CPC G01N 21/9501; G01N 2201/0636; G01N 2201/0638; G01N 2201/102
USPC 356/51; 356/237.1

(57) ABSTRACT

An image acquisition device based on photo-thermal imaging, including a support beam, a translational electric motor, an imaging probe, and a light emitter. The translational electric motor is fixed to the lower side of the beam, and the imaging probe is perpendicularly fixed to a moving block in the translational electric motor. The light emitter is connected to the moving block via an adjustable connection piece, and by adjusting the adjustable connection piece, light emitted by the light emitter enters the imaging probe after being reflected by a sample. The moving block in the translational electric motor is configured to move the light emitter and the imaging probe in the radial direction right above the sample. The light emitter is configured to emit light on the upper surface of the sample. The imaging probe is configured to image reflected light from the upper surface of the sample.

### CROSS-REFERENCE TO RELATED APPLICATIONS

This application is a continuation-in-part of International Patent Application No. PCT/CN2012/084560 with an international filing date of Nov. 14, 2012, designating the United States, now pending, and further claims priority benefits to Chinese Patent Application No. 201210366219.4 filed Sep. 28, 2012. The contents of all of the aforementioned applications, including any intervening amendments thereto, are incorporated herein by reference. Inquiries from the public to applicants or assignees concerning this document or the related applications should be directed to: Matthias Scholl P. C., Attn.: Dr. Matthias Scholl Esq., 245 First Street, 18^{th} Floor, Cambridge, Mass. 02142.

### BACKGROUND OF THE INVENTION

1. Field of the Invention

The invention relates to a device and method for detecting the quality level of microelectronic packaging samples using photo-thermal imaging.

2. Description of the Related Art

3D microelectronic packaging technology, also known as stereoscopic electronic packaging technology, is an electronic packaging with higher density developed from 2D electronic packaging and can enable a corresponding electronic system to perform better and cost less, and to have more functions and higher stability. Through -Silicon-Via technology, used as a new solution to achieve interconnection of stacking chips in 3D integrated circuits, has the following significant advantages: stacking density of the chips is the highest in the third dimension, interconnection wires of the chips is the shortest, and the size is the smallest, so as to effectively realize stacking of 3D chips to obtain chips feature a more complex structure, higher performance and lower cost. Therefore, silicon via technology is one of the most noticeable technologies in present electronic packaging.

However, restricted by feature size, aspect ratio of a micropore, etc., various types of Through -Silicon-Via technologies still have many process problems to be solved. In particular, detecting process quality of semi-finished and finished products at multiple stages of a process is of great importance for improving product yield, identifying waste products, avoiding unnecessary operations in the following process, and reducing production costs. Similar problems also exist in 2D flip-chip packaging, wafer level packaging and system level packaging based on embedded active components and passive components. For example, thousands of blind vias should be prepared before arranging copper pillar pads on a wafer, and the size, depth and residue of the blind vias should be measured or tested so as to enable the following process to work smoothly.

### SUMMARY OF THE INVENTION

In view of the above-mentioned problems, it is an objective of the invention to provide a device for detecting quality of microelectronic packaging samples based on photo-thermal imaging.

To achieve the above objective, in accordance with one embodiment of the invention, there is provided an image acquisition device based on photo-thermal imaging, comprising a support beam, a translational electric motor, an imaging probe, and a light emitter. The translational electric motor is fixed to the lower side of the beam, and the imaging probe is perpendicularly fixed to a moving block in the translational electric motor. The light emitter is connected to the moving block via an adjustable connection piece, and by adjusting the adjustable connection piece, light emitted by the light emitter enters the imaging probe after being reflected by a sample. The moving block in the translational electric motor is configured to move the light emitter and the imaging probe in a radial direction right above the sample. The light emitter is configured to emit light on the upper surface of the sample. The imaging probe is configured to image reflected light from the upper surface of the sample.

In accordance with another embodiment of the invention, there is provided an image acquisition device based on photo-thermal imaging, comprising a support beam, a translational electric motor, an imaging probe, a transflective prism, and a light emitter. The translational electric motor is fixed to the lower side of the beam, and the imaging probe is perpendicularly fixed to a moving block in the translational electric motor. The transflective prism is located in the front of the imaging probe. The light emitter and the transflective prism are located on the same plane. The moving block in the translational electric motor is configured to move the imaging probe in a radial direction right above a sample. The light emitter is configured to provide a light source for the transflective prism. The transflective prism is configured to enable incident light from the transflective prism perpendicular on the upper surface of the sample. The imaging probe is configured to image reflected light from the upper surface of the sample.

In a class of one embodiment, the imaging probe comprises an imaging sensor and an imaging camera which are mutually connected via a bolt, and the imaging camera is configured according to different samples. The imaging sensor is configured to obtain light images or thermal images.

In a class of one embodiment, the image acquisition device further comprises an optical element located in the front of the light emitter and is configured to filter and calibrate light emitted from the light emitter.

In a class of one embodiment, the light emitter is a laser emitter or an infrared light emitter.

In accordance with still another embodiment of the invention, there is provided a device for detecting quality of microelectronic packaging samples based on photo-thermal imaging, comprising an image acquisition device, an operating platform, a control device and a data processing device. The image acquisition device is the image acquisition device illustrated above and is configured to obtain data of light images and thermal images by scanning the upper surface of the sample by the imaging probe. The operating platform is configured to place a sample. The control device is configured to control the sample to rotate at a constant speed. The data processing device is configured to process data of light images and thermal images obtained by the image acquisition device so as to obtain a correlation coefficient and a statistical coefficient of the mean squared error, compare the correlation coefficient and the statistical coefficient of the mean squared error with preset threshold values, and obtain a technology quality assessment according to the comparison result.

In a class of this embodiment, the device further comprises a heating element disposed at the bottom of the sample and is configured to heat the lower surface of the sample by radio frequency thermal radiation.

In accordance with a further embodiment of the invention, there is provided a method for detecting quality of microelectronic packaging technology based on photo-thermal imaging, the method comprising:

S1: obtaining data of light images and thermal images by scanning the upper surface of a sample by an imaging probe;

S2: determining the size of a central area according to the number of pixels of light images or thermal images corresponding to a system error; performing correlation search in a second image and calculating correlation coefficients with respect to a central area of a first image; an overlapped area of the two images corresponding to the maximum correlation coefficient being a image sub region; the first image is a light image or a thermal image of a test sample, and the second image is a light image or a thermal image of a standard sample or a same area in a test sample;

S3: calculating a correlation coefficient and a statistical coefficient of the mean squared error according to the image sub-regions; and

S4: comparing the correlation coefficient and the statistical coefficient of the mean squared error with preset threshold values, and performing process quality assessment according to the comparison result.

In a class of this embodiment, in step S2 and step S3, the correlation coefficient is derived by the following equation:

$$C = \frac{{\sum }_{i = 1}^{m} {\sum }_{j = 1}^{n} [ f ( {x}_{i} , {y}_{j} ) - \overline{f} ] [ g ( {x}_{i}^{*} , {y}_{j}^{*} ) - \overline{g} ]}{\sqrt{{\sum }_{i = 1}^{m} {\sum }_{j = 1}^{n} {[ f ( {x}_{i} , {y}_{j} ) - \overline{f} ]}^{2} {\sum }_{i = 1}^{m} {\sum }_{j = 1}^{n} {[ g ( {x}_{i}^{*} , {y}_{j}^{*} ) - \overline{g} ]}^{2}}}$$

C represents a correlation function, (xᵢ, yⱼ) is a relative coordinate of each pixel of the image sub-region of the sample using the central point as the origin, f(xᵢ, yⱼ) is a discrete gray value distribution function of the image sub-region of the sample, (x*ᵢ, y*ⱼ) is a relative coordinate of each pixel of the image sub-region of the standard sample or the same area of the test sample using the central point as the origin, g(x*ᵢ, y*ⱼ) is a gray value distribution function of the image sub-region of the standard sample or the same area of the test sample corresponding to f(xᵢ, yⱼ), f̅ represents an average value of f(xᵢ, yⱼ), g̅ represents an average value of g(x*ᵢ, y*ⱼ).

In a class of this embodiment, in step S4, the threshold values are set according to system calibration and process requirements.

Advantages according to embodiments of the invention comprise:

(1) packaging process relates to multiple kinds of materials, and heat conduction rate and intensity of light reflection and light absorption vary greatly as the material varies. Besides, differences in geometric construction, such as residue particles, size and structure of pores, cavities, may also affect thermal distribution and intensity of light reflection in local areas. The present invention takes advantage of the above features, records thermal images and images of intensity of light reflection as data images, and performs quantitative comparative analysis on differences in images of different local areas and differences between images of a test sample and a standard sample, so as to realize measurement of micropore depth and identification of residue particles, cavities and materials. The detection and evaluation are more reliable by integrating results derived by the above two features.

(2) only one imaging probe is required for recording images of heat distribution and images of intensity of light reflection, quantitative statistical analysis is performed on light images and photo images by comparing a test sample with a standard sample according to the fact that processing specifications of different local areas are the same, and the result is more reliable considering multiple groups of data. Besides, the present invention takes fully advantage that light is more suitable for precise positioning analysis and that heat is more suitable for identifying residue particles result from local micro processing. In particular, the latter is very important for silicon via technology while few testing methods are available currently.

(3) requirements for processing units increase in packaging process. For example, aspect ratio of a micropore reaches 20:1 in silicon via technology and diameter of the micropore is only a few micrometers, so that a dark area is inevitable for bottom imaging of the micropore when the incident light is oblique and images of corners of cliffy micro structures are hard to obtain by ordinary optical measurements. For the present invention, vertical positioning is more precise for incident and reflected light by introducing coaxial optical structures and zoom camera lens, and amplification factor of imaging (resolution) can be changed by adjusting camera lens so as to meet more measuring requirements.

(4) two motors are introduced, and scanning is accomplished by the probe moving horizontally driven by an upper motor and by the sample rotating driven by a lower motor, which is more suitable for circle-shaped packaging elements in silicon via technology and can reduce the requirement for stiffness of scanning structures.

### BRIEF DESCRIPTION OF THE DRAWINGS

FIG. 1 is a schematic diagram of a device for detecting quality of microelectronic packaging samples based on photo-thermal imaging according to a first embodiment of the present invention;

FIG. 2 is a schematic diagram of a device for detecting quality of microelectronic packaging samples based on photo-thermal imaging according to a second embodiment of the present invention; and

FIG. 3 is a flow chart of a method for detecting quality of microelectronic packaging technology based on photo-thermal imaging according to one embodiment of the present invention.

### DETAILED DESCRIPTION OF THE EMBODIMENTS

For clear understanding of the objectives, features and advantages of the invention, detailed description of the invention will be given below in conjunction with accompanying drawings and specific embodiments. It should be noted that the embodiments are only meant to explain the invention, and not to limit the scope of the invention.

The device for detecting quality of microelectronic packaging samples based on photo-thermal imaging provided by the present invention is able to detect process quality at different stages of a process flow of microelectronic packaging technology, and is especially suitable for detecting quality of semi-finished and finished products derived from different stages of a process flow of flip chip packaging, wafer level packaging, or 3D IC packaging based on silicon vias. Besides, the device can also be used for advanced packaging technologies such as embedded system level packaging. As a result, product yield may be improved and cost may be reduced.

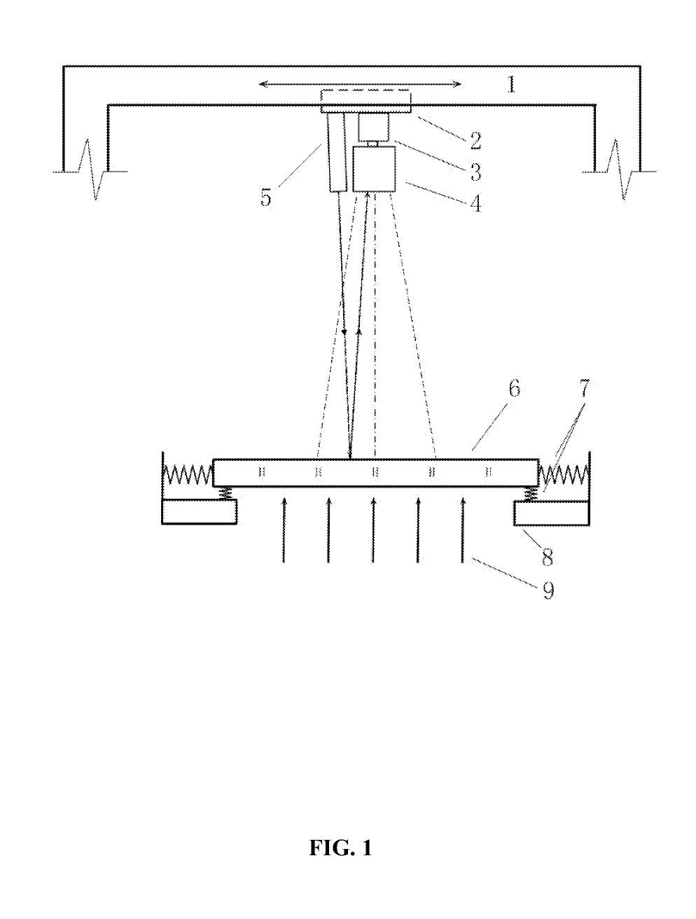

FIG. 1 shows a schematic diagram of a device for detecting quality of microelectronic packaging samples based on photo-thermal imaging according to a first embodiment of the present invention. It should be noted that only structure related to the first embodiment of the present invention is illustrated for convenient description, and more details are explained as follows.

A device for detecting quality of microelectronic packaging samples based on photo-thermal imaging comprises an image acquisition device, an operating platform, a control device and a data processing device. the image acquisition device is configured to obtain data of light images and thermal images by scanning the upper surface of a sample by an imaging probe, the operating platform is configured to place the sample, the control device is configured to control the sample to rotate at a constant speed, and the data processing device is configured to process data of light images and thermal images obtained by the image acquisition device so as to obtain a correlation coefficient and a statistical coefficient of the mean squared error, compare the correlation coefficient and the statistical coefficient of the mean squared error with preset threshold values, and obtain a technology quality assessment according to the comparison result.

The image acquisition device comprises a support beam 1, a translational electric motor 2, the imaging probe and a light emitter 5. The translational electric motor 2 is fixed to the lower side of the beam, and the imaging probe is perpendicularly fixed to a moving block in the translational electric motor 2. The light emitter 5 is connected to the moving block via an adjustable connection piece, and by adjusting the adjustable connection piece, light emitted by the light emitter enters the imaging probe after being reflected by the sample. The moving block in the translational electric motor 2 is configured to move the light emitter 5 and the imaging probe in a radial direction right above the sample 6, the light emitter 5 is configured to emit light on the upper surface of the sample 6, and the imaging probe is configured to image reflected light from the upper surface of the sample 6.

In operation, the sample 6 rotates around its central axis at a constant speed under the control of the control device and its lower surface is heated. The light emitter 5 and the imaging probe moves in a radial direction right above the sample 6 driven by the moving block of the translational electric motor 2; light is emitted by the light emitter 5 on the upper surface of the sample 6 and the reflected light is imaged by the imaging probe, and the control device controls the imaging probe to perform thermal imaging on the same location of the sample 6 thereafter; scanning on the upper surface of the sample 6 is accomplished by the sample rotating and the light emitter 5 and the imaging probe moving in a radial direction.

In the first embodiment of the present invention, the support beam 1 is used for supporting, and the translational electric motor 2 is fixed to the lower surface of the beam by a bolt, the translational electric motor 2 contains a guide which is arranged in the same direction as the beam. The imaging probe and the light emitter 5 moves horizontally above the sample driven by the translational electric motor 2 so as to scan the surface of the sample for imaging, and scanning path and scanning positions of the translational electric motor 2 and each of the captured images of each of the scanning positions are controlled and recorded by the data processing device. The light emitter 5 moves driven by the translational electric motor 2 and light is emitted on the upper surface of the sample 6 by the light emitter 5. Light reflectivity varies due to differences in reflectivity of the material and differences in geometric depth of the irradiated position. Therefore, light intensity of the imaging signal of the reflected light received by the infrared imaging probe varies correspondingly so as to establish a corresponding relationship of pore depth measurement, material identification and local coordinate positions based on reflected images and scanning positions.

In the first embodiment of the present invention, the imaging probe is fixed to the moving block of the translational electric motor by a bolt, the central axis of imaging is kept perpendicular to the surface of the sample by adjusting a flexible pad of the bolt, and the imaging probe moves in a radial direction passing through the central axis of the sample to image the upper surface of the sample. The imaging probe comprises an imaging sensor 3 and an imaging camera 4 which are mutually connected via a bolt, the imaging sensor 3 is photo sensitive and thermal sensitive, and the imaging camera 4 can be arranged according to different samples. The imaging components are connected to a data line and a control line of the control device which transfers image data to a hard disk of a computer via the data line and controls the imaging sensor to be photo sensitive or thermal sensitive via the control line.

In the embodiment of the present invention, the operating platform comprises a sample clamping element 7 and a sample supporting table 8. The sample 6 is clamped by the sample clamping element 7 and is fixed to the sample supporting table 8. Imaging scanning on the surface of the sample is realized by the translational electric motor illustrated above and a rotating micro-step motor 10 which drives the sample supporting table to rotate so as to lead the sample to rotate around its central axis. scanning path and scanning positions of the translational electric motor and each of the captured images of each of the scanning positions are controlled and recorded by the data processing device. The device for detecting quality of microelectronic packaging samples based on photo-thermal imaging provided by the present invention is especially suitable for process defect detecting, micropore size measurement, identification and removing of residue particles result from micropore processing, etc. in a process flow of 3D microelectronic packaging or silicon via technology, so as to realize quality assessment of semi-finished and finished products derived from different process stages.

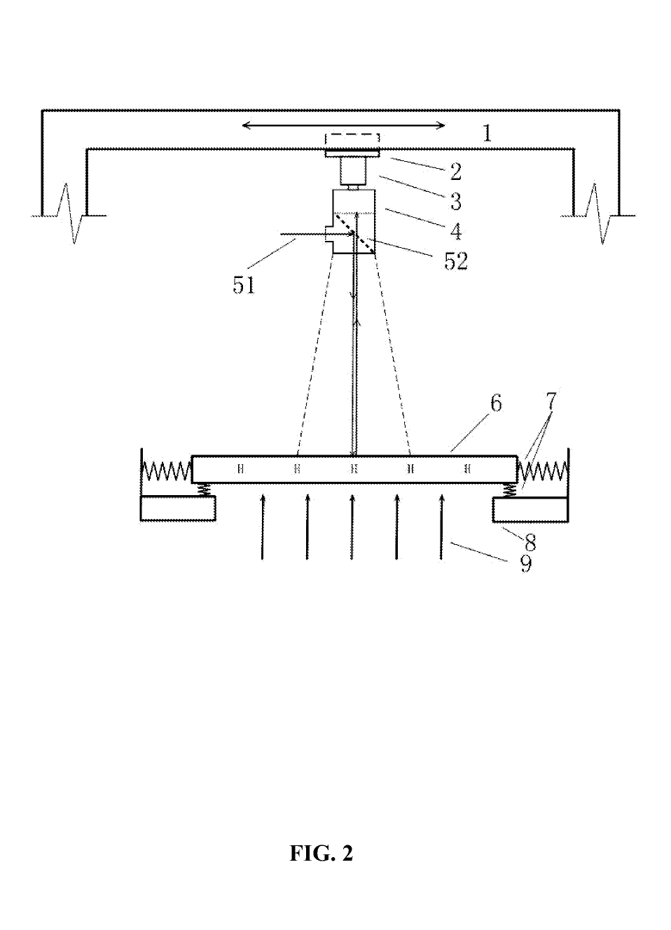

FIG. 2 shows a schematic diagram of a device for detecting quality of microelectronic packaging samples based on photo-thermal imaging according to a second embodiment of the present invention. Compared with the first embodiment, an image acquisition device with a different structure is provided, and other components are the same and will not be further illustrated.

The image acquisition device comprises the support beam 1, the translational electric motor 2, the imaging probe, a transflective prism 52 and a light emitter. The translational electric motor is fixed the lower side of the beam, and the imaging probe is perpendicularly fixed to the moving block in the translational electric motor. The transflective prism is located in the front of the imaging probe, and the light emitter and the transflective prism are located on the same plane. The moving block in the translational electric motor is configured to move the imaging probe in a radial direction right above the sample, the light emitter is configured to provide a light source for the transflective prism, the transflective prism is configured to enable incident light therefrom to perpendicularly inject on the upper surface of the sample, and the imaging probe is configured to image reflected light from the upper surface of the sample. In FIG. 2, the light source provided by the light emitter is represented by 51.

In operation, the sample 6 rotates around its central axis at a constant speed under the control of the control device and its lower surface is heated. The imaging probe moves in a radial direction right above the sample 6 driven by the moving block of the translational electric motor. The incident light is perpendicular on the upper surface of the sample 6 and the reflected light is imaged by the imaging probe, and the control device controls the imaging probe to perform thermal imaging on the same location of the sample 6 thereafter; scanning on the upper surface of the sample 6 is accomplished by the sample rotating and the imaging probe moving in a radial direction.

In the second embodiment of the present invention, both the incident light and the reflected light can be arranged perpendicular on the upper surface of the sample by connecting a coaxial optical device with a fiber. The coaxial optical device is an optical element coated with a transflective film, which can be connected to the front end of a camera or be integrated with a camera.

In the above two embodiments, the device for detecting quality of microelectronic packaging samples based on photo-thermal imaging further comprises an optical element located in the front of the light emitter and is configured to filter and calibrate light emitted from the light emitter so as to insure the uniformity of the incident light.

In the above two embodiments, the device for detecting quality of microelectronic packaging samples based on photo-thermal imaging further comprises a heating element disposed at the bottom of the sample and is configured to heat the lower surface of the sample 6 by radio frequency thermal radiation. The heating element 9 is arranged under the sample for heating.

In the above two embodiments, the light emitter may be a laser emitter or an infrared light emitter. For a laser emitter, the wavelength of the emitter should be determined according to the reflectivity of the material of the test sample.

In the present invention, thermal imaging and light reflection imaging can be realized by one element by a numerical control switch. Geometric parameters such as micropore depth can be measured quantitatively and the material can be identified by computing thermal radiation digital images and light reflection digital images, analyzing differences in thermal radiation and light reflection due to differences in geometric features and materials, and combining numerical control scanning positions, material identification is especially important for identifying and removing process residues.

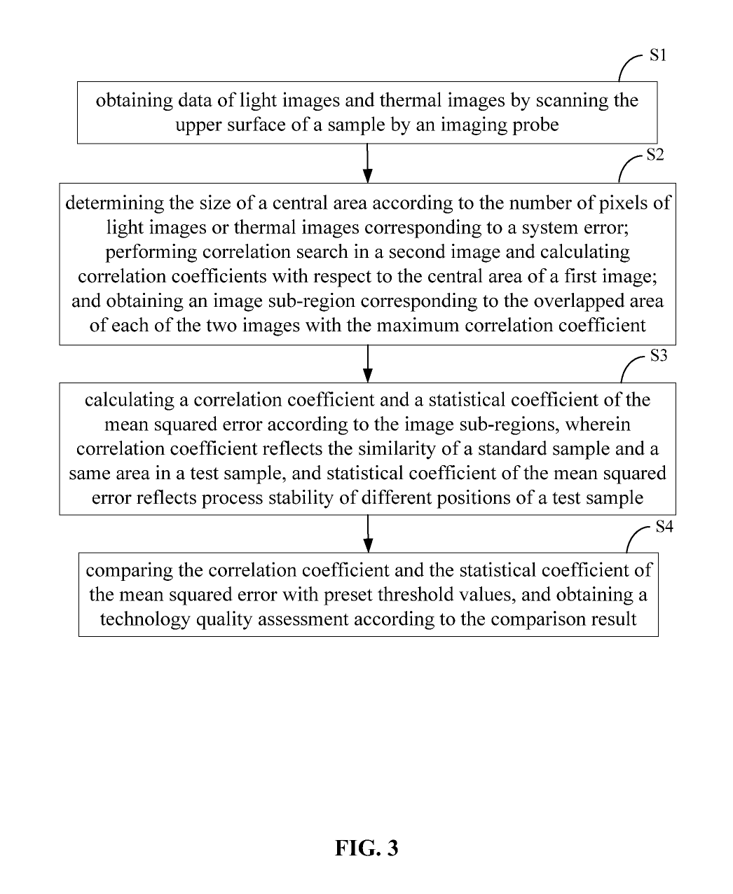

As in FIG. 3, there is provided a method for detecting quality of microelectronic packaging technology based on photo-thermal imaging in the present invention, comprising:

S1: obtaining data of light images and thermal images by scanning the upper surface of a sample by an imaging probe;

S2: determining the size of a central area according to the number of pixels of light images or thermal images corresponding to a system error; performing correlation search in a second image and calculating correlation coefficients with respect to the central area of a first image; and obtaining an image sub-region corresponding to an overlapped area of the two images with the maximum correlation coefficient;

the first image is a light image or a thermal image of a test sample, and the second image is a light image or a thermal image of a standard sample or a same area in a test sample;

S3: calculating a correlation coefficient and a statistical coefficient of the mean squared error according to the image sub-regions, correlation coefficient reflects the similarity of a standard sample and a same area in a test sample, and statistical coefficient of the mean squared error reflects process stability of different positions of a test sample; and

S4: comparing the correlation coefficient and the statistical coefficient of the mean squared error with preset threshold values, and performing process quality assessment according to the comparison result, preset threshold values are set according to system calibration and process requirements.

Specific operations for detecting a sample by the device for detecting quality of microelectronic packaging samples based on photo-thermal imaging of the present invention are as follows:

1) putting a sample on the sample supporting table by clamping, and moving the upper translational electric motor to a position right above the sample;

2) enabling the probe to focus on the sample by adjusting the lens aperture, the focal length and the height of the upper translational electric motor with respect to the sample (object distance);

3) starting the radiant heat source and the motors, the upper translational electric motor moves a unit step after the rotating motor rotates a circle for scanning imaging, and the scanning is accomplished by repeating the above steps;

4) collecting a thermal radiation image and a light reflection image respectively at each of the scanning positions and storing the images in the control device, collecting and switching of the two types of images and recording of the scanning positions are realized automatically under the control of the control device;

5) performing computing on each of the scanning positions, comprising analyzing differences among local areas of an image, comparing with a typical image in a data base (image of a standard sample), and analyzing by combining the two types of images, and obtaining statistical differences in heat distribution of the local areas and pore depth derived by converting the differences in light reflectivity; and

6) performing statistical analysis on the analyzing result of step (5) in the range of the whole sample, and obtaining a comprehensive assessment of the quality of the sample.

Specifically, analyzing and computing should be performed by the control device and the data processing device on the images after finishing the above process of controlled scanning and image acquisition, comprising: (1) comparing and analyzing thermal images of different positions; (2) comparing and analyzing light reflection images of different positions; and (3) comparing with light images and thermal images of the standard sample, so that comprehensive statistical analysis and process quality assessment can be realized. A single sample applied in the packaging technology illustrated above comprises multiple groups of local structures such as pores and grooves which should be identical, and process quality can be estimated by comparing and analyzing images of different positions. As for thermal images, differences in internal quality of micropores (such as residues) will inevitably lead to thermal radiation differences corresponding to the micropores which further reflect in infrared thermal images. As for light reflection images, light is emitted on the upper surface of the sample 6 by the light emitter moved by the motor; since light reflectivity is different due to differences in material reflectivity and differences in geometric depth of irradiated positions, light intensity of imaging signals of reflected light received by the infrared imaging probe is correspondingly different; and a corresponding relationship of pore depth measurement, material identification and local coordinate positions based on reflected images and scanning positions. Comparative analysis is realized mainly by statistical correlation algorithm, correlation formula specifically, which can quantify correlation of two local images by a correlation coefficient C. Statistical analysis is realized by calculating a coefficient of the mean squared error S by mean squared error statistical algorithm, for example, the mean squared error of an image of each of the scanning positions can be obtained, and a further mean squared error statistical operation can be performed on mean squared errors or correlation coefficients of all the scanning positions. A correlation coefficient reflects the similarity between a position and a same position of a standard sample, and a statistical coefficient of the mean squared error reflects process stability of different positions. Correlation between the calculated values and the process quality is determined by system calibration and process requirements.

Correlation formula is as follows:

$$C = \frac{{\sum }_{i = 1}^{m} {\sum }_{j = 1}^{n} [ f ( {x}_{i} , {y}_{j} ) - \overline{f} ] [ g ( {x}_{i}^{*} , {y}_{j}^{*} ) - \overline{g} ]}{\sqrt{{\sum }_{i = 1}^{m} {\sum }_{j = 1}^{n} {[ f ( {x}_{i} , {y}_{j} ) - \overline{f} ]}^{2} {\sum }_{i = 1}^{m} {\sum }_{j = 1}^{n} {[ g ( {x}_{i}^{*} , {y}_{j}^{*} ) - \overline{g} ]}^{2}}} ,$$

C represents a correlation function, f(xᵢ, yⱼ) is a discrete gray value distribution function of the image sub-region of the sample, (xᵢ, yⱼ) is a relative coordinate of each pixel of the image sub-region of the sample using the central point as the origin, g(x*ᵢ, y*ⱼ) is a gray value distribution function of the image sub-region of the standard sample or the same area of the test sample corresponding to f(xᵢ, yⱼ), (x*ᵢ, y*ⱼ) is a relative coordinate of each pixel of the image sub-region of the standard sample or the same area of the test sample using the central point as the origin, f̅ represents an average value of f(xᵢ, yⱼ), g̅ represents an average value of g(x*ᵢ, y*ⱼ).

A correlation coefficient calculated by the above formula reaches an extreme value (a maximum of 1) if each element of a gray value sequence extracted by function f(xᵢ, yⱼ) is equal or close to each corresponding element of a gray value sequence extracted by function g(x*ᵢ, y*ⱼ), and position of a sub-region extracted from the image of a same area of the test sample is determined as search target position thereafter. m and n represent number of pixels in the sub-regions respectively, i and j represent labels of the pixels respectively, and (x, y) represents a coordinate. For example, when m=3 and n=3, there are a total of 9 pixels around, and x=(−1 0 1) and y=(−1 0 1). Combine any two of them. For example, if the central point is (0,0), coordinates of pixels around are as follows: (−1,−1), (−1,0), (−1,1). . .

Advantages according to embodiments of the invention comprise:

1. packaging process relates to multiple kinds of materials, and heat conduction rate and intensity of light reflection and light absorption vary greatly as the material varies. Besides, differences in geometric construction, such as residue particles, size and structure of pores, cavities, etc., may also affect thermal distribution and intensity of light reflection in local areas. The present invention takes advantage of the above features, records thermal images and images of intensity of light reflection as data images, and performs quantitative comparative analysis on differences in images of different local areas and differences between images of a test sample and a standard sample, so as to realize measurement of micropore depth and identification of residue particles, cavities and materials. The detection and evaluation are more reliable by integrating results derived by the above two features.

2. only one imaging probe is required for recording images of heat distribution and images of intensity of light reflection, quantitative statistical analysis is performed on light images and photo images by comparing a test sample with a standard sample according to the fact that processing specifications of different local areas are the same, and the result is more reliable considering multiple groups of data. Besides, the present invention takes fully advantage that light is more suitable for precise positioning analysis and that heat is more suitable for identifying residue particles result from local micro processing. In particular, the latter is very important for silicon via technology while few testing methods are available currently.

3. requirements for processing units increase in packaging process. For example, aspect ratio of a micropore reaches 20:1 in silicon via technology and diameter of the micropore is only a few micrometers, so that a dark area is inevitable for bottom imaging of the micropore when the incident light is oblique and images of corners of cliffy micro structures are hard to obtain by ordinary optical measurements. For the present invention, vertical positioning is more precise for incident and reflected light by introducing coaxial optical structures and zoom camera lens, and amplification factor of imaging (resolution) can be changed by adjusting camera lens so as to meet more measuring requirements.

4. two motors are introduced, and scanning is accomplished by the probe moving horizontally driven by an upper motor and by the sample rotating driven by a lower motor, which is more suitable for circle-shaped packaging elements in silicon via technology and can reduce the requirement for stiffness of scanning structures.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. An image acquisition device, comprising:
a) a support beam;
b) a translational electric motor;
c) an imaging probe; and
d) a light emitter; wherein
said translational electric motor is fixed to a lower side of said support beam, and said imaging probe is perpendicularly fixed to a moving block in said translational electric motor; said light emitter is connected to said moving block via an adjustable connection piece, and by adjusting the adjustable connection piece, light emitted by said light emitter enters said imaging probe after being reflected by a sample;
the moving block in said translational electric motor is configured to move said light emitter and said imaging probe in a radial direction right above the sample;
said light emitter is configured to emit light to an upper surface of the sample;
said imaging probe is configured to image reflected light from the upper surface of the sample.

2. The device of claim 1, wherein said imaging probe comprises an imaging sensor and an imaging camera which are mutually connected via a bolt, said imaging camera is configured according to different samples; and said imaging sensor is configured to obtain light images or thermal images.

3. The device of claim 1, further comprising an optical element located in the front of said light emitter and configured to filter and calibrate light emitted from said light emitter.

4. The device of claim 1, wherein said light emitter is a laser emitter or an infrared light emitter.

5. An image acquisition device, comprising:
a) a support beam;
b) a translational electric motor;
c) an imaging probe;
d) a transflective prism; and
e) a light emitter; wherein
said translational electric motor is fixed to a lower side of the beam, and said imaging probe is perpendicularly fixed to a moving block in said translational electric motor; said transflective prism is located in the front of said imaging probe; said light emitter and said transflective prism are located on the same plane;
said moving block in said translational electric motor is configured to move said imaging probe in a radial direction right above a sample;
said light emitter is configured to provide a light source for said transflective prism;
said transflective prism is configured to enable incident light from said transflective prism to perpendicularly inject on an upper surface of said sample;
said imaging probe is configured to image reflected light from the upper surface of the sample.

6. The device of claim 5, wherein said imaging probe comprises an imaging sensor and an imaging camera which are mutually connected via a bolt, said imaging camera is configured according to different samples; and said imaging sensor is configured to obtain light images or thermal images.

7. The device of claim 5, further comprising an optical element located in the front of said light emitter and configured to filter and calibrate light emitted from said light emitter.

8. The device of claim 5, wherein said light emitter is a laser emitter or an infrared light emitter.

9. A device for detecting quality of microelectronic packaging samples, the device comprising the image acquisition device of claim 1, an operating platform, a control device, and a data processing device, wherein
said operating platform is configured to place a sample;
said control device is configured to control the sample to rotate at a constant speed;
said image acquisition device is configured to obtain data of light images and thermal images by scanning the upper surface of the sample by said imaging probe; and
said data processing device is configured to process data of light images and thermal images obtained by said image acquisition device so as to obtain a correlation coefficient and a statistical coefficient of the mean squared error, to compare said correlation coefficient and said statistical coefficient of the mean squared error with preset threshold values, and to obtain a technology quality assessment according to the comparison result.

10. The device of claim 9, further comprising a heating element disposed at a bottom of said sample and configured to heat a lower surface of said sample by radio frequency thermal radiation.
